(19) United States
(12) Patent Application Publication
(10) Pub. No.: US 2026/0279295 A1
(43) Pub. Date: Sep. 17, 2026

(54) DISPLAY DEVICE

(71) Applicant: Sharp Kabushiki Kaisha, Sakai City, Osaka (JP)

(72) Inventors: Takafumi MIURA, Sakai City (JP); Masamitsu KOBAYASHI, Sakai City (JP); Ryoh KIKUCHI, Sakai City (JP); Hiroshi FUKUSHIMA, Sakai City (JP)

(21) Appl. No.: 19/564,579

(22) Filed: Mar. 12, 2026

(30) Foreign Application Priority Data
Mar. 17, 2025 (JP) 2025-042811

(51) Int. Cl. G09G 3/34; G09G 3/00

(52) U.S. Cl. CPC G09G 3/3426; G09G 3/006; G09G 2320/0233; G09G 2320/0271; G09G 2320/068; G09G 2330/021; G09G 2330/12

(57) ABSTRACT

A display device capable of presenting a first image to a first user positioned in front of a display surface and a second image to a second user positioned lateral to the display surface, the second image being different from the first image, and the display device comprises a display panel having a first display pixel group for forming the first image on the display surface and a second display pixel group for forming the second image on the display surface; a backlight configured to emit illuminating light toward the first display pixel group and the second display pixel group; a barrier configured to prevent a portion of a first light and a portion of a second light from traveling toward the display surface, the first light being the illuminating light having a wavelength converted with the first display pixel group, and the second light being the illuminating light having a wavelength converted with the second display pixel group; and a control unit configured to control the display panel and the backlight, wherein the backlight is divided into a plurality of areas, the backlight has a light source for each of the plurality of areas, the light source is allowed to be independently controlled in each of the plurality of areas, a data set is prepared in advance to indicate a luminance corresponding to each of a plurality of test patterns in which a black display image is displayed as the first image and all the areas of the backlight are illuminated at maximum luminance, and the control unit converts a gray level of the second image in accordance with luminance distribution observed of the backlight and corresponding to the first image and with the data set.

### CROSS-REFERENCE TO RELATED APPLICATION

The present application claims priority from Japanese Application JP2025-042811, the content of which is hereby incorporated by reference into this application.

### BACKGROUND

### Technical Field

An aspect of the present disclosure relates to a display device.

### Background Art

There is a display device capable of presenting, on a single display surface, a plurality of individual images in a viewing direction of a user (a viewer). Such a display device is referred to as a multi-view display device. Japanese Unexamined Patent Application Publication No. 2019-154008 describes an exemplary configuration of the multi-view display device.

### SUMMARY

An aspect of the present disclosure sets out to provide a multi-view display device with higher display quality than ever before.

A display device according to an aspect of the present disclosure is capable of presenting a first image to a first user positioned in front of a display surface and a second image to a second user positioned lateral to the display surface. The second image is different from the first image. The display device includes: a display panel having a first display pixel group for forming the first image on the display surface and a second display pixel group for forming the second image on the display surface; a backlight that emits illuminating light toward the first display pixel group and the second display pixel group; a barrier that prevents a portion of a first light and a portion of a second light from traveling toward the display surface, the first light being the illuminating light having a wavelength converted with the first display pixel group, and the second light being the illuminating light having a wavelength converted with the second display pixel group; and a control unit that controls the display panel and the backlight. The backlight is divided into a plurality of areas. The backlight has a light source for each of the plurality of areas. The light source is allowed to be independently controlled in each of the plurality of areas. A data set is prepared in advance to indicate a luminance corresponding to each of a plurality of test patterns in which a black display image is displayed as the first image and all the areas of the backlight are illuminated at maximum luminance. The control unit converts a gray level of the second image in accordance with luminance distribution observed of the backlight and corresponding to the first image and with the data set.

### Advantageous Effect of Disclosure

Thanks to an aspect of the present disclosure, a multi-view display device can achieve higher display quality than ever before.

### BRIEF DESCRIPTION OF DRAWINGS

FIG. 1 is a block diagram illustrating an exemplary configuration of a display device according to a reference embodiment;

FIG. 2 schematically illustrates dual-view display according to the reference embodiment;

FIG. 3 shows various kinds of light that involves the dual-view display in an exemplary ideal operation of the display device according to the reference embodiment;

FIG. 4 illustrates an example of a first image viewed by a first user and an example of a second image viewed by a second user in the exemplary ideal operation of the display device according to the reference embodiment;

FIG. 5 shows various kinds of light that involves the dual-view display in an exemplary actual operation of the display device according to the reference embodiment;

FIG. 6 illustrates an example of a first image viewed by the first user and an example of a second image viewed by the second user in the exemplary actual operation of the display device according to the reference embodiment;

FIG. 7 is a block diagram illustrating an exemplary configuration of a display device according to a first embodiment;

FIG. 8 schematically illustrates dual-view display according to the first embodiment;

FIG. 9 shows an exemplary operation of a display device BL according to the first embodiment;

FIG. 10 shows a problem that an LD multi-view display device could develop;

FIG. 11 shows a plurality of test patterns according to the first embodiment;

FIG. 12 is a graph showing an exemplary correspondence relationship between a gray level of a second image and a luminance measured at a second position, both of which are obtained as a result of measurement in the plurality of test patterns shown in FIG. 11 as an example;

FIG. 13 is a table showing a correspondence relationship between TV_lateral and LM_lateral seen in FIG. 12 as an example;

FIG. 14 shows an example of a first image according to the first embodiment and an example of BL luminance distribution corresponding to the first image;

FIG. 15 is a graph showing the BL luminance distribution in an X-axis direction in the example of FIG. 14;

FIG. 16 illustrates an exemplary correction on a second image according to the first embodiment;

FIG. 17 shows an exemplary case where, according to the first embodiment, a converted second image, which is illustrated in FIG. 16 as an example, is presented to the second user under the BL luminance distribution corresponding to the first image;

FIG. 18 is a graph showing an exemplary correspondence relationship between BL_lumi and TV_lateral according to the first embodiment; and

FIG. 19 is a table showing a correspondence relationship between BL_lumi and TV_lateral seen in FIG. 18 as an example.

### DESCRIPTION OF EMBODIMENTS

### Reference Embodiment

Prior to the description of a display device 1P according to a first embodiment, described below will be a display device 1 according to a reference embodiment. For convenience in description, like reference signs designate components (constituent elements) having identical functions between the reference embodiment and the following embodiments. These components will not be elaborated upon repeatedly. Furthermore, for the sake of brevity, descriptions of features seen in known technical issues are also omitted as appropriate. The components and the numerical values described in this Specification are solely examples unless otherwise contradicting. Hence, for example, positional relationships and connection relationships of the components shall not be limited to examples of the drawings unless otherwise contradicting.

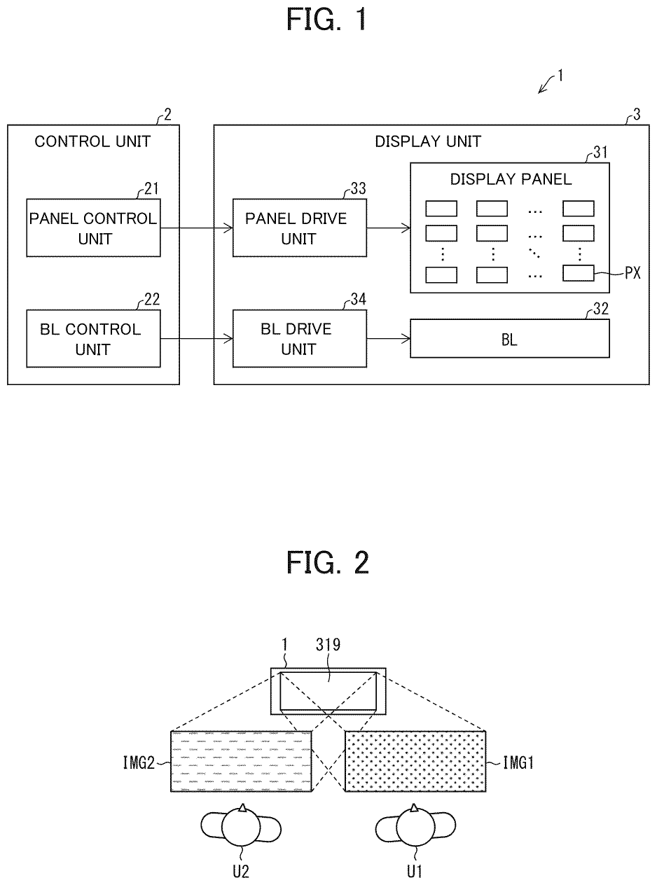

FIG. 1 is a block diagram illustrating an exemplary configuration of the display device 1. The display device 1 includes: a control unit 2; and a display unit 3. The display device 1 may be either a portable information terminal or a stationary display device. In this Specification, a term “backlight” is abbreviated as “BL”. Typically, the display device 1 is a liquid crystal display device.

The control unit 2 has centralized control of the components of the display device 1. The control unit 2 according to the reference embodiment functions as a display control device that controls display of the display unit 3. The control unit 2 includes: a panel control unit 21; and a BL control unit 22. Hence, the control unit 2 controls a display panel 31 and a BL 32 to be described below.

The panel control unit 21 generates liquid crystal data corresponding to any given input image. The liquid crystal data is data indicating spatial distribution of liquid crystal transmittance (transmittance of light through liquid crystal) of the display panel 31. The panel control unit 21 supplies the generated liquid crystal data to a panel drive unit 33 to be described below.

The BL control unit 22 generates BL data corresponding to an input image. The BL data is data indicating spatial distribution of luminance in the BL 32. The BL control unit 22 supplies the generated BL data to a BL drive unit 32 to be described below.

The display unit 3 displays the input image in accordance with an instruction of the control unit 2. Typically, the display unit 3 is a liquid crystal display. In the example of FIG. 1, the display unit 3 includes: the display panel 31; the BL 32; the panel drive unit 33; and the BL drive unit 34.

The display panel 31 has a display region in which a plurality of display pixels PX are arranged. Typically, the display panel 31 is a liquid crystal display panel. The display panel 31 displays a predetermined image in accordance with an instruction of the control unit 2.

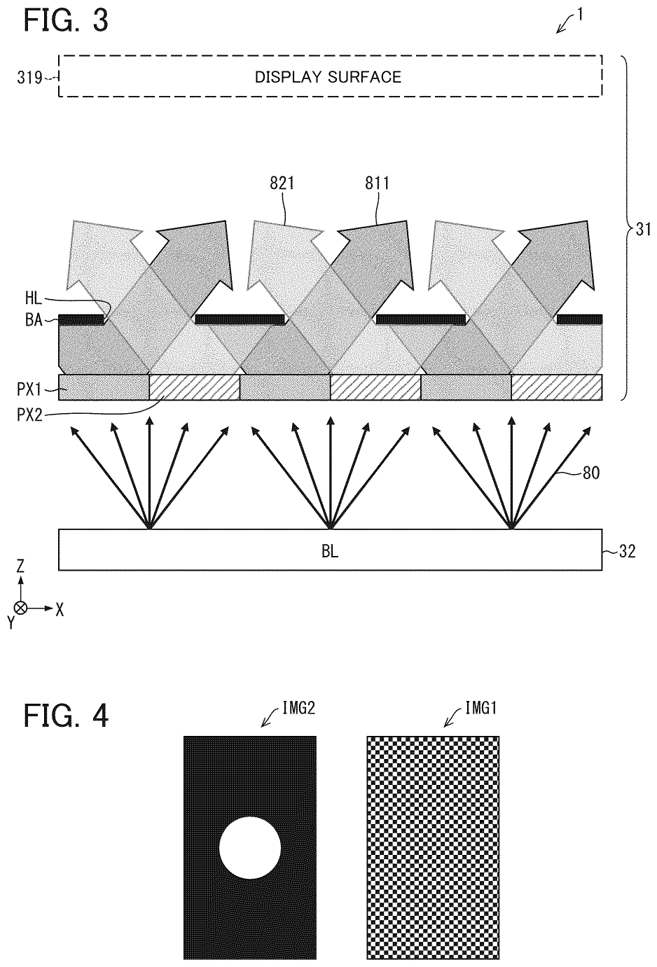

In this Specification, for convenience in description, an XYZ Cartesian coordinate system is used in, for example, FIG. 3 to be shown later. An X-direction and a Y-direction respectively correspond to a column direction and a row direction of the display panel 31. As can be understood from FIG. 3, a Z-direction is a direction normal to a display surface 319 of the display panel 31. In this Specification, a user of the display device 1 is assumed to be positioned on a positive side in the Z-direction. Hence, the positive side in the Z-direction is also referred to as a viewer side. Whereas, a negative side in the Z-direction is also referred to as a substrate side. In this Specification, the Z-direction is also a thickness direction of the display device 1.

As can be understood from the above description, an XY plane in this Specification is a plane in parallel with the display surface 319 of the display panel 31. As illustrated in FIG. 1, the display panel 31 has the plurality of display pixels PX regularly arranged in the X-direction and the Y-direction.

The BL 32 has a light source (not shown in the drawings of the reference embodiment). The light source may be any given type of light-emitting element. The BL 32 may have one or more light sources. When light emitted from the light-emitting elements is controlled, spatial distribution of luminance in the BL can be controlled. The BL 32 emits illuminating light toward the display unit 3.

This Specification exemplifies a case where the BL 32 has a white light-emitting diode (LED) to serve as a light source. Hence, this Specification exemplifies a case where the illuminating light is a white light. In the reference embodiment, the light sources of the BL 32 are controlled uniformly. That is, the BL 32 in the reference embodiment is a non local-dimming (LD) BL.

The panel drive unit 33 drives the display panel 31 in accordance with the liquid crystal data obtained from the panel control unit 21. Specifically, in accordance with the liquid crystal data, the panel drive unit 33 changes light transmittance of the display panel 31 at each of the positions.

The BL drive unit 34 drives the BL 32 in accordance with the BL data obtained from the BL control unit 22. Specifically, the BL drive unit 34 controls a light-emitting state of the BL 32 in accordance with the BL data. More specifically, in accordance with the BL data, the BL drive unit 34 controls light luminance of the light source in the BL 32.

As described above, the control unit 2 displays the input image on the display panel 31 by (i) causing the panel drive unit 33 to drive the display panel 31 and (ii) causing the BL drive unit 34 to drive the BL 32.

In the reference embodiment, the display device 1 is a multi-view liquid crystal display device. For the sake of brevity in description, the reference embodiment exemplifies a case where the display device 1 is a dual-view liquid crystal display device. Hence, the display device 1 can present two images (perform dual-view display) in a viewing direction of the user.

In this Specification, one of the two images in the dual-view display is referred to as a first image, and an other image is referred to as a second image. In the reference embodiment, the display device 1 is an example of a dual-view liquid crystal display device known in the art. The reference embodiment exemplifies a case where the second image is different from the first image. Note that, as will be exemplified in the first embodiment later, the second image according to an aspect of the present disclosure may be a common image with the first image.

FIG. 2 schematically illustrates dual-view display performed on the first display device 1. As an example, FIG. 2 illustrates two users as viewers of the images displayed on the display device 1. In this Specification, one of the two users is referred to as a first user U1, and an other user is referred to as a second user U2.

As illustrated in FIG. 2, the display device 1 (specifically the display panel 31) has the display surface 319. In this Specification, the first user U1 is assumed to be positioned at a first position in relation to the display surface 319 and the second user U2 is positioned at a second position in relation to the display surface 319. In this Specification, the second position is different from the first position.

In the example of FIG. 2, the first user U1 is positioned on the right of the drawing in relation to the display surface 319, and the second user U2 is positioned on the left of the drawing in relation to the display surface 319. Hence, FIG. 2 exemplifies a case where the second position is across from the first position. In the example of FIG. 2, a first image IMG1 is an image to be presented to the first user U1. Whereas, a second image IMG2 is an image to be presented to the second user U2.

### Example of Dual View in Reference Embodiment

FIGS. 3 and 4 illustrate an exemplary ideal operation of the display device 1 performing the dual-view display. FIG. 3 shows various kinds of light that involve the dual-view display in the exemplary ideal operation of the display device 1. First, described with reference to FIG. 3 is an example of a dual-view structure (a hardware structure for devising a dual-view display device) of the display device 1.

As illustrated in FIG. 3, the display panel 31 is positioned closer toward a viewer than the BL 32. The reference embodiment exemplifies a case where the display panel 31 is an RGB (red, green, and blue) liquid crystal display panel. In the example of the reference embodiment, one display pixel PX includes one red sub display pixel, one green sub display pixel, and one blue sub display pixel.

In the example of FIG. 3, the BL 32 emits illuminating light 80 as a white light toward the display pixels PX (specifically, each of a first display pixel group PX1 and a second display pixel group PX2 to be described below). In the reference embodiment, each of the light sources in the BL 32 emits the illuminating light 80. The illuminating light 80 is uniform in luminance regardless of the positions of the light sources. In the example of FIG. 3, the illuminating light 80 is assumed not to have a particular directivity.

In the example of the reference embodiment, the red sub display pixel has a red color filter, the green sub display pixel has a green color filter, and the blue sub display pixel has a blue color filter. Hence, of the white light emitted from the BL 32, a white light incident on the red sub display pixel is converted into a red light. Of the white light emitted from the BL 32, a white light incident on the green sub display pixel is converted into a green light. Of the white light emitted from the BL 32, a white light incident on the blue sub display pixel is converted into a blue light. In the display panel 31, the red light, the green light, and the blue light emitted from the display pixels PX and traveling toward a viewer form an image (specifically an RGB image) on the display surface 319.

As described above, the display device 1 is a dual-view liquid crystal display device. Hence, in the example of FIG. 3, the display panel 31 has the first display pixel group PX1 and the second display pixel group PX2. The first display pixel group PX1 is a group of display pixels PX for displaying the first image. Whereas, the second display pixel group PX2 is a group of display pixels PX for displaying the second image.

In the example of FIG. 3, the first display pixel group PX1 is a group of display pixels PX each having an odd column number. Hence, for example, a display pixel PX positioned in a first column belongs to the first display pixel group PX1. Furthermore, a display pixel PX positioned in a third column also belongs to the first display pixel group PX1. Whereas, in the example of FIG. 3, the second display pixel group PX2 is a group of display pixels PX each having an even column number. Hence, for example, a display pixel PX positioned in a second column belongs to the second display pixel group PX2. Furthermore, a display pixel PX positioned in a fourth column also belongs to the second display pixel group PX2.

As can be seen, the display panel 31 has first display pixel groups PX1 and second display pixel groups PX2 alternately positioned in the X-direction. Hence, for example, when the display panel 31 is observed in a direction from the first position toward the second position (e.g., in the X-direction), the first display pixel groups PX1 and the second display pixel groups PX2 can be alternately positioned in the display panel 31.

As illustrated in FIG. 3, the display panel 31 further has a barrier BA. The barrier BA may contain any given light-absorbing material. The barrier BA is also referred to as a parallax barrier. The barrier BA could be referred to as a light-blocking portion. In the example of FIG. 3, when viewed from the display surface 319, the barrier BA partially covers the first display pixel groups PX1 and the second display pixel groups PX2. That is, the barrier BA is positioned closer toward the viewer than the first display pixel groups PX1 and the second display pixel groups PX2.

In this Specification, when the illuminating light 80 emitted from the BL 32 has a wavelength converted with the first display pixel group PX1, the converted light (e.g. color-converted light) is referred to as a first light. Whereas, when the illuminating light 80 emitted from the BL 32 has a wavelength converted with the second display pixel group PX2, the converted light is referred to as a second light. The barrier BA prevents a portion of the first light from traveling toward the display surface 319 and prevents a portion of the second light from traveling toward the display surface 319.

Described next will be various kinds of light that involves the dual view of the display device 1. As described above, the BL drive unit 34 drives the BL 32 in accordance with the instruction of the BL control unit 32. Hence, as seen in FIG. 3, the illuminating light 80 is emitted from the BL 32 toward the first display pixel group PX1 and the second display pixel group PX2.

Simultaneously, the panel drive unit 33 drives the display panel 31 in accordance with the instruction of the panel control unit 21. Specifically, the panel drive unit 33 individually drives the first display pixel group PX1 and the second display pixel group PX2 in accordance with the instruction of the panel control unit 21. As can be seen, the panel control unit 21 causes the panel drive unit 33 to individually drive the first display pixel group PX1 and the second display pixel group PX2 so as to respectively display the first image IMG1 and the second image IMG2 on the display panel 31.

In the exemplary ideal operation for the dual view, the barrier BA has a light absorptivity of 100%. Hence, as illustrated in FIG. 3, the barrier BA has an opening HL formed to transmit a portion of the first light and a portion of the second light. In the example of FIG. 3, when viewed from the display surface 319, the opening HL is positioned to partially expose each of the first display pixel group PX1 and the second display pixel group PX2.

Hence, a portion of the first light, which has directivity toward the first position, passes through the opening HL and travels toward the display surface 319. In FIG. 3, a light 811 is an example of the first light having the directivity toward the first position, passing through the opening HL, and traveling toward the display surface 319. The light 811, which has the directivity toward the first position, contributes to formation of the first image IMG1 on the display surface 319.

Whereas, a portion of the second light, which has directivity toward the second position, passes through the opening HL and travels toward the display surface 319. In FIG. 3, a light 821 is an example of the second light having the directivity toward the second position, passing through the opening HL, and traveling toward the display surface 319. The light 821, which has the directivity toward the second position, contributes to formation of the second image IMG2 on the display surface 319.

FIG. 4 illustrates an example of the first image IMG1 viewed by the first user U1 and an example of the second image IMG2 viewed by the second user U2 in the exemplary ideal operation of the display device 1. FIG. 4 corresponds to the example of FIG. 3 described above. In FIG. 4, the first image IMG1 is a checked image with black and white. In FIG. 4, the second image IMG2 is an image with a black background and a white circle positioned in the center.

The example of FIG. 4 is an ideal example. Hence, no crosstalk occurs between the first image IMG1 viewed by the first user U1 and the second image IMG2 viewed by the second user U2. The crosstalk in this Specification means a phenomenon of the multi-view display; that is, an image that a user is supposed to view is mixed together with another image that another user is supposed to view. In the description of and after the reference embodiment, described as an example of the crosstalk will be a case where one image is mixed together with another image in the dual view display.

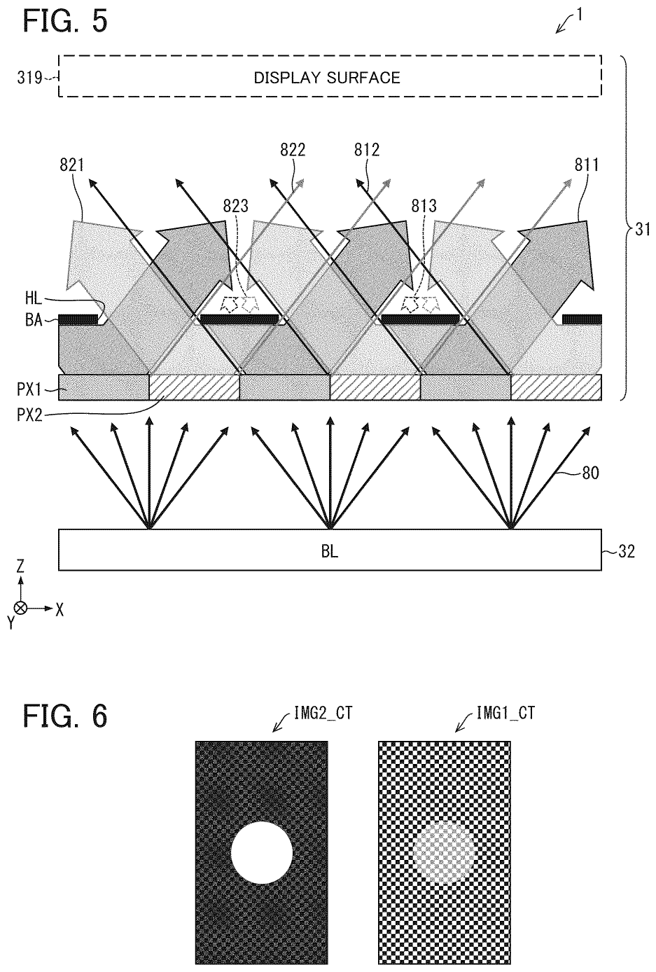

FIGS. 5 and 6 illustrate an exemplary actual operation of the display device 1 performing the dual-view display. FIG. 5 and FIG. 6 are respectively in pair with FIG. 3 and FIG. 4 above. First, reference is made to FIG. 5. In the exemplary actual operation, unlike the example of FIG. 3 described above, the light included in the first light and having the directivity toward the second position is not completely blocked with the barrier BA. For example, in the exemplary actual operation, a portion of the first light passes through the opening HL and travels toward the display surface 319. In FIG. 5, a light 812 is an example of the first light having directivity toward the second position, passing through the opening HL, and traveling toward the display surface 319.

Likewise, in the exemplary actual operation, the light included in the second light and having the directivity toward the first position is not completely blocked with the barrier BA. For example, in the exemplary actual operation, a portion of the second light passes through the opening HL and travels toward the display surface 319. In FIG. 6, a light 822 is an example of the second light having the directivity toward the first position, passing through the opening HL, and traveling toward the display surface 319.

In addition, the barrier BA has an actual light absorptivity of below 100%. Hence, in the exemplary actual operation, a portion of the first light passes through a portion included in the barrier BA and having the first display pixel group PX1 and the second display pixel group PX2 overlapping with each other, and travels toward the display surface 319. Likewise, a portion of the second light passes through the portion and travels to the display surface 319. In FIG. 5, a light 813 is an example of the first light having the directivity toward the second position, passing through the portion, and traveling toward the display surface 319. A light 823 is an example of the second light having the directivity toward the first position, passing through the portion, and traveling toward the display surface 319.

FIG. 6 illustrates an example of a first image IMG1_CT viewed by the first user U1 and an example of a second image IMG2_CT viewed by the second user U2 in the exemplary actual operation of the display device 1. As seen in FIG. 5, in the exemplary actual operation, a portion of the first light is inevitably routed to the second position.

Hence, the second image IMG2_CT in the example of FIG. 6 is the second image IMG2 in the example of FIG. 4 with which the first image IMG1 in the example of FIG. 4 is mixed, The mixture of the first image IMG1 with the second image IMG2 is due to the light 812 and the light 813 in the example of FIG. 5. As can be seen, the light 812 and the light 813 are an example of an undesirable first light for the dual-view display.

Likewise, in the exemplary actual operation, a portion of the second light is inevitably routed to the first position. Hence, the first image IMG1_CT in the example of FIG. 6 is the first image IMG1 in the example of FIG. 4 with which the second image IMG2 in the example of FIG. 4 is mixed, The mixture of the second image IMG2 with the first image IMG1 is due to the light 822 and the light 823 in the example of FIG. 5. As can be seen, the light 822 and the light 823 are an example of an undesirable second light for the dual-view display.

### First Embodiment

As can be seen, the crosstalk could deteriorate display quality of a multi-view display device. Hence, in order to improve the display quality of the multi-view display device, various techniques are under development.

The inventors of the present application (hereinafter simply referred to as “inventors”) have newly produced the display device 1P of the first embodiment as a display device different from a conventional one. As will be described below, the display device 1P; that is, an LD multi-view display device, is different from the display device 1 according to the reference embodiment. Thanks to the display device 1P, a multi-view display device can achieve higher display quality than ever before. Specifically, thanks to the display device 1P, an LD multi-view display device can achieve higher display quality than ever before.

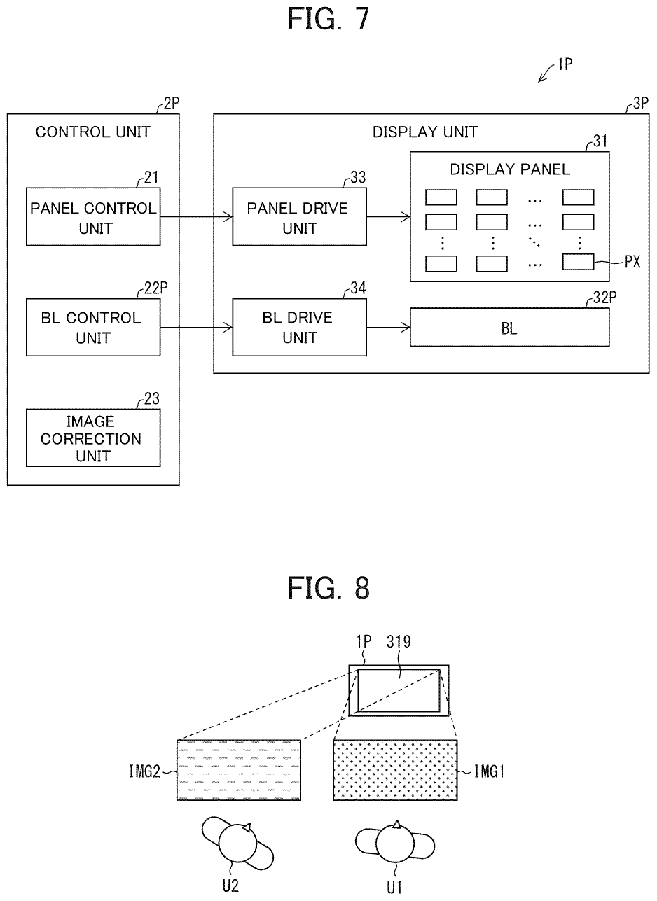

FIG. 7 is a block diagram illustrating an exemplary configuration of the display device 1P. FIG. 7 is in pair with FIG. 1 above. The display device 1P includes: a control unit 2P; and a display unit 3P. The control unit 2P includes a BL control unit 22P instead of the BL control unit 22. Then, unlike the control unit 2, the control unit 2P further includes an image correction unit 23.

The display unit 3P includes a BL 32P instead of the BL 32. Unlike the BL 32 of the reference embodiment, the BL 32P of the first embodiment is an LD-type BL. Hence, the display device 1P is an example of an LD multi-view display device.

FIG. 8 schematically illustrates dual-view display performed on the first display device 1P. FIG. 8 is in pair with FIG. 2 above. In the example of FIG. 8, unlike the example of FIG. 2, the first user U1 is positioned in front of the display surface 319. Hence, FIG. 8 exemplifies a case where the first position is in front of the display surface 319. Hence, in the first embodiment, the first image IMG may be referred to as a front image.

Whereas, in the first embodiment, the second user U2 is assumed to be positioned lateral to the display surface 319. That is, in the first embodiment, the second position is assumed to be lateral to the display surface 319. Hence, in the first embodiment, the second image IMG may be referred to as a lateral image. FIG. 8 exemplifies a case where the second position is on the left of the drawing in relation to the display surface 319. Note that, in the first embodiment, the second position may also be on the right of the drawing in relation to the display surface 319.

The first embodiment exemplifies a case where an image is mainly presented to the first user U1. As an example, the display device 1P may be installed in an automobile. In this case, for example, the first user U1 is a person (a non-driver) sitting in a passenger seat of the automobile, and the second user U2 is a person (a driver) sitting in a driver seat of the automobile.

In this case, an example of the first image in the dual-view display may be a content image unrelated to driving of the automobile (e.g., an entertainment content image). Moreover, an example of the second image in the dual-view display may be a content image related to driving of the automobile (e.g., an information image presented with software of a car navigation system).

Note that, in order to allow the second user U2 to concentrate on driving of the automobile, the second user U2 might be preferably undistracted from driving with the second image as a content image. Hence, the display device 1P has display modes including a privacy mode. In the privacy mode, a black display image is presented as the second image. The black display image in this Specification is an image in which all the gray levels are a minimum gray level (i.e., a gray level of 0).

In this Specification, images that are not the black display image are collectively referred to as non-black display images. In this Specification, the non-black display images include a white display image and a halftone level display image. The white display image in this Specification is an image in which all the gray levels are a maximum gray level (i.e., a gray level of 255). Moreover, the halftone level display image is an image corresponding neither to the black display image nor to the white display image.

In this Specification, among the display modes of the display device 1P, display modes other than the privacy mode are collectively referred to as non-privacy modes. The display device 1P may be switched between the display modes on any given condition. Hence, as an example, in accordance with the condition, the control unit 2P may switch the display modes of the display device 1P from a non-privacy mode to the privacy mode.

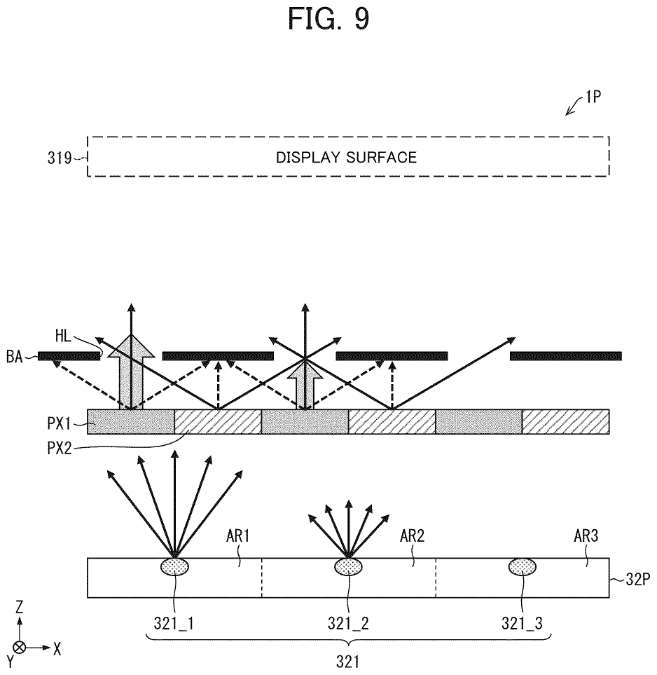

FIG. 9 shows an exemplary operation of the BL 32P. As described above, the BL 32P is an LD-type BL. Hence, the BL 32P is divided into a plurality of areas. In FIG. 9, a first area AR1, a second area AR2, and a third area AR3 are an example of the plurality of areas in the BL 32P. In the BL 32P, the plurality of areas may be divided either one dimensionally or two dimensionally.

The BL 32P has a light source 321 for each of the plurality of areas. As an example of the light source 321, FIG. 8 shows a first light source 321_1, a second light source 321_2, and a third light source 321_3. The first light source 321_1 is a light source in the first area AR1. The second light source 321_2 is a light source in the second area AR2. The third light source 321_3 is a light source in the third area AR3.

Then, the light source 321 of the BL 32P is allowed to be independently controlled in each of the plurality of areas in the BL 32P. Hence, the BL control unit 22P generates a BL data item corresponding to an input image and each of a plurality of the light sources 321 of the BL 32P. The BL control unit 22P supplies the generated BL data item to the BL drive unit 34.

In the first embodiment, in accordance with the BL data item supplied from the BL control unit 22P, the BL drive unit 34 independently controls the light luminance of each of the plurality of light sources 321 of the BL 32P. That is, in accordance with the BL data item supplied from the BL control unit 22P, the BL drive unit 34 independently controls the light luminance of each of the plurality of areas in the BL 32P.

In this way, the BL 32P can perform LD display based on the input image. The LD display can improve a contrast ratio of the image to be displayed on the display surface 319. The LD display also contributes to a reduction in power consumption of the BL 32P.

In the example of FIG. 9, the first area AR1 corresponds to a maximum gray level area (an image area having the maximum gray level) among areas of the input image. Hence, in the example of FIG. 9, the first light source 321_1 is higher in light luminance than the second light source 321_2.

In the example of FIG. 9, the second area AR2 corresponds to a halftone level area (an image area having a halftone level lower than the maximum gray level and higher than the minimum gray level) among the areas of the input image. Hence, in the example of FIG. 9, the second light source 321_2 is lower in light luminance than the first light source 321_1.

In the example of FIG. 9, the third area AR3 corresponds to a minimum gray level area (an image area having the minimum gray level) among the areas of the input image. In the first embodiment, the minimum gray level is set to 0. Hence, in the example of FIG. 9, the third light source 321_3 has a light luminance of 0. That is, in the example of FIG. 9, the third light source 321_3 is in a non-light-emitting state.

Note that, in the example of FIG. 9, the barrier BA is formed on the precondition for a positional relationship between the users illustrated in FIG. 8 as an example. In the example of FIG. 9, most of the first display pixel group PX1 is not covered with the barrier BA. Hence, most of the first light emitted from the first display pixel group PX1 passes through the opening HL and reaches the display surface 319. As a result, the first image IMG1 to be presented to the first user U1 is formed on the display surface 319 with the first light reaching the display surface 319. In the first embodiment, the first display pixel group PX1 is configured so that the first light emitted from the first display pixel group PX1 has directivity mainly toward the first position.

Whereas, the second display pixel group PX2 is covered with the barrier BA. Exemplified is a case where the second image IMG2 serving as the non-black display image is presented to the second user U2. Most of the second light emitted from the second display pixel group PX2 is blocked with the barrier BA. However, a portion of the second light emitted from the second display pixel group PX2 has directivity of traveling lateral to the display surface 319. Hence, the portion of the second light, which is emitted from the second display pixel group PX2 and having the directivity of traveling lateral to the display surface 319, passes through the opening HL and reaches the display surface 319. As a result, the second image IMG2 to be presented to the second user U2 is formed on the display surface 319 with the second light reaching the display surface 319.

### Problem that LD Multi-View Display Device Could Develop

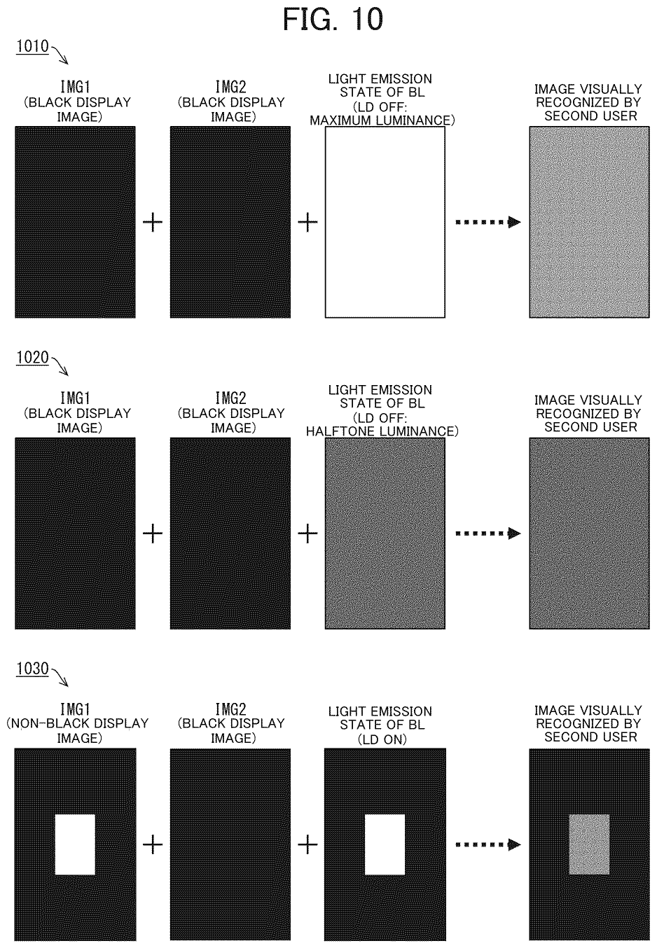

FIG. 10 shows a problem that an LD multi-view display device could develop. In the example of FIG. 10, the privacy mode described above is assumed. Hence, FIG. 10 exemplifies a case where the second image IMG2 is a black display image. In the example of FIG. 10, the plurality of areas in the BL 32P includes areas divided two-dimensionally. Hence, in the example of FIG. 10, the plurality of light sources 321 of the BL 32P is distributed two-dimensionally.

In FIG. 10, a reference numeral 1010 shows an example of an image that is visually recognized by the second user U2 at the second position in a case where, in the first embodiment, the first image IMG1 is a black display image, the second image IMG2 is a black display image, and all the areas in the BL 32P are illuminated at the maximum luminance. The example of the reference numeral 1010 shows an example of an image visually recognized by the second user U2 if the BL 32P is driven with LD ON.

In FIG. 10, an example of a reference numeral 1020 is in pair with the example of the reference numeral 1010. The reference numeral 1020 shows an example of an image that is visually recognized by the second user U2 at the second position in a case where, in the first embodiment, the first image IMG1 is a black display image, the second image IMG2 is a black display image, and all the areas in the BL 32P are illuminated at halftone luminance (luminance lower than the maximum luminance and higher than the minimum luminance). The example of the reference numeral 1020 shows another example of the image visually recognized by the second user U2 if the BL 32P is driven with LD OFF.

As can be understood from the examples of the reference numerals 1010 and 1020, the higher the luminance is of the BL 32P, the higher the luminance is of the light visible at the second position. Hence, the higher the luminance is of the BL 32P, the more apparent the crosstalk is to be visible by the second user U2 at the second position.

In FIG. 10, an example of a reference numeral 1030 shows an example of an image visually recognized by the second user U2 if the BL 32P is driven with LD ON. In the example of the reference numeral 1030, unlike the examples of the reference numerals 1010 and 1020, the first image IMG1 is a non-black display image. The reference numeral 1030 shows an example of an image that is visually recognized by the second user U2 at the second position in a case where, in the first embodiment, the first image IMG1 is a non-black display image, the second image IMG2 is a black display image, and the BL 32P is driven with LD ON.

In the example of the reference numeral 1030, the first image IMG1 serving as a non-black display image has a center portion provided with the maximum gray level area. In the example of the reference numeral 1030, an area of the first image IMG1 other than the center portion is the minimum gray level area. Hence, in the example of the reference numeral 1030, the first image IMG1 is an example of a halftone level display image.

In the example of the reference numeral 1030, the BL control unit 22P generates a BL data item corresponding to the first image IMG1 serving as a non-black display image and to each of the plurality of light sources 321 of the BL 32P. In the example of the reference numeral 1030, a light emission state of the BL corresponds to the BL data item.

Hence, in the example of the reference numeral 1030, distribution of light emitted from the BL corresponds to distribution of gray levels in the first image IMG1 serving as a non-black display image. Specifically, in the example of the reference numeral 1030, an area included in the areas of the BL 32P and corresponding the center portion of the first image IMG1 (the maximum gray level area) has luminance set to the maximum luminance. Whereas, an area included in the areas of the BL 32P and corresponding to the area of the first image IMG1 other than the center portion (the minimum gray level area) has luminance set to the minimum luminance.

As described in the examples of the reference numerals 1010 and 1020, the higher the luminance is of the BL 32P, the more apparent the crosstalk is to be visible at the second position. Hence, in the example of the reference numeral 1030, an image corresponding to the center portion of the first image IMG1 as a non-black display image is mixed with the second image IMG2 serving as a black display image, and the image mixed with the second image IMG2 is visually recognized noticeably by the second user U2.

### How to Reduce Crosstalk Visually Recognized by Second User at Second Position

As can be seen, if the BL 32P is driven with LD ON, the crosstalk, which is visually recognized by the second user U2 at the second position, could be apparent. This is not preferable because the apparent crosstalk defeats the purpose of the privacy mode.

In view of the problem that an LD multi-view display device could develop, the inventors have come up with a new idea of reducing the crosstalk while driving the BL 32P with LD ON. Specifically, the inventors have come up with a new idea of correcting the second image IMG2 so that BL luminance distribution (distribution of luminance in the BL 32P) is cancelled, in order to reduce the crosstalk. The display device 1P is created on the basis of the new idea. Hence, as described above, unlike the display device 1, the display device 1P includes the image correction unit 23.

In the first embodiment, a data set is assumed to be prepared in advance to indicate a luminance corresponding to each of a plurality of test patterns in which a black display image is displayed as the first image IMG1 and all the areas of the BL 32P are illuminated at the maximum luminance. The data set is typically a data set obtained by a prior experiment by a producer of the display device 1P. In the first embodiment, the image correction unit 23 has the data set. As will be described later, the image correction unit 23 corrects the second image IMG2 on the basis of the data set. Specifically, based on the data set, the image correction unit 23 corrects a gray level of the second image IMG2.

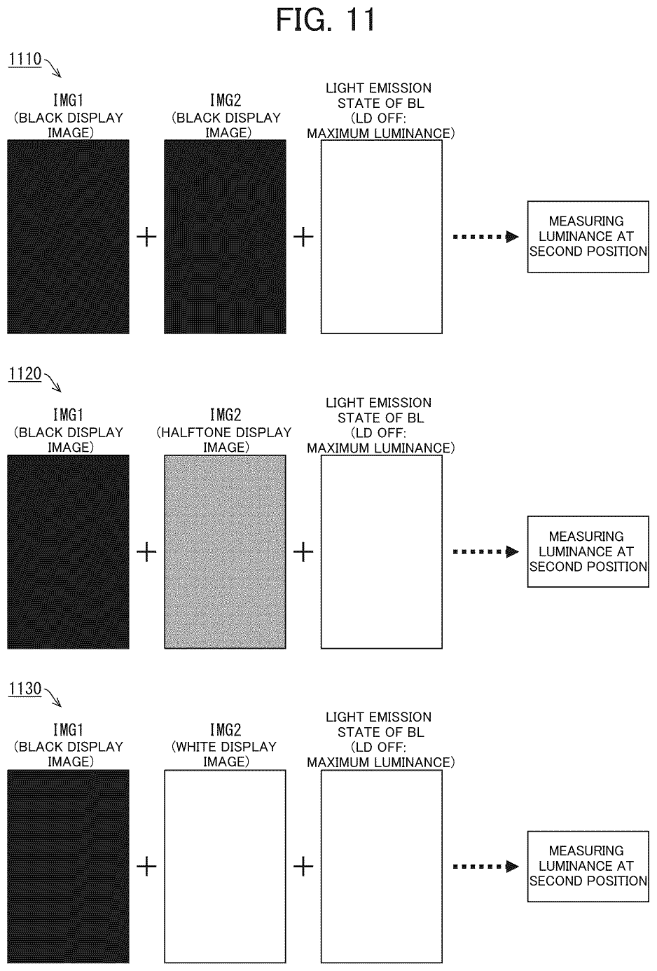

FIG. 11 shows the plurality of test patterns. As an example, the data set, which indicates a luminance corresponding to each of the plurality of test patterns in which a black display image is displayed as the first image IMG1 and all the areas of the BL 32P are illuminated at the maximum luminance, may be a data set to indicate a luminance observed of each of the plurality of test patterns and measured at the second position. In FIG. 11, reference numerals 1110 to 1130 indicate examples of the test patterns in the first embodiment. The first embodiment exemplifies a case where the plurality of test patterns includes test patterns denoted by the reference numerals 1110 to 1130.

The reference numeral 1110 denotes a test pattern in which a black display image is displayed as the first image IMG1, a black display image is displayed as the second image IMG2, and all the areas of the BL 32P are illuminated at the maximum luminance. The test pattern denoted by the reference numeral 1110 as an example may also be referred to as a black display test pattern of the second image IMG2. The data set in the first embodiment includes a data set indicating a luminance observed of the black display test pattern and measured at the second position.

The reference numeral 1120 denotes a test pattern in which a black display image is displayed as the first image IMG1, a halftone display image is displayed as the second image IMG2, and all the areas of the BL 32P are illuminated at the maximum luminance. The test pattern denoted by the reference numeral 1120 as an example may be referred to as a halftone display test pattern of the second image IMG2. The data set in the first embodiment includes a data set indicating a luminance observed of the halftone display test pattern and measured at the second position.

The plurality of test patterns may include a plurality of halftone display test patterns each corresponding to one of a plurality of the second images IMG2 serving as different halftone display images. In the example of the reference numeral 1120, for the sake of brevity in illustration, all the pixels for the second image IMG2 serving as a halftone display image have the same gray level. Note that, for the halftone display image used in a halftone display test pattern as the second image IMG2, the gray levels of all the pixels do not have to be the same.

The reference numeral 1130 denotes a test pattern in which a black display image is displayed as the first image IMG1, a white display image is displayed as the second image IMG2, and all the areas of the BL 32P are illuminated at the maximum luminance. The test pattern denoted by the reference numeral 1130 as an example may also be referred to as a white display test pattern of the second image IMG2. The data set in the first embodiment includes a data set indicating a luminance observed of the white display test pattern and measured at the second position.

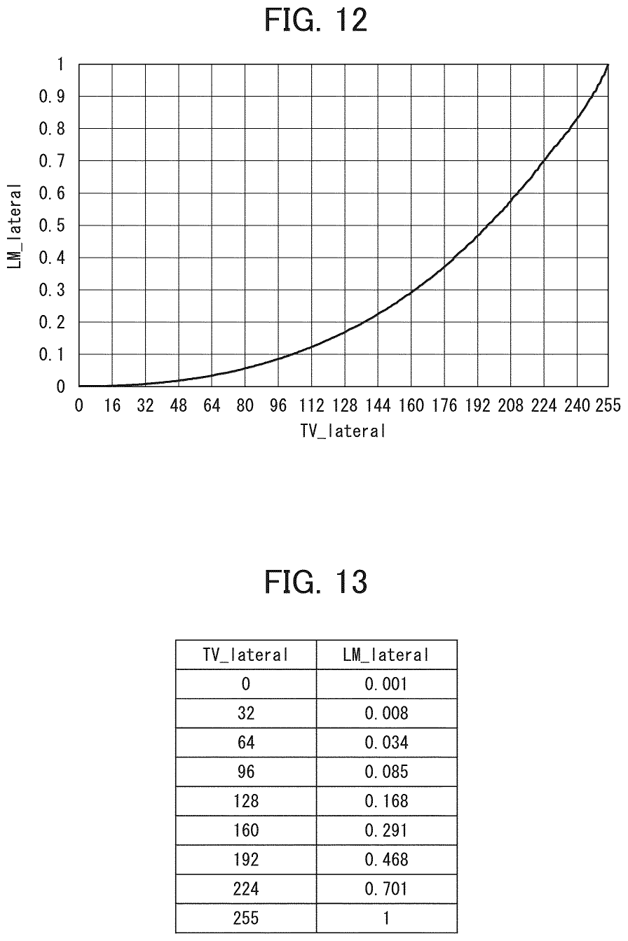

FIG. 12 is a graph showing an exemplary correspondence relationship between a gray level of the second image IMG2 and a luminance measured at the second position, both of which are obtained as a result of measurement in the plurality of test patterns shown in FIG. 11 as an example. In the graph of FIG. 12, the horizontal axis represents a gray level of a pixel for the second image IMG2. In the example of FIG. 12, the gray level is denoted as TV_lateral.

In the graph of FIG. 12, the vertical axis represents a luminance corresponding to TV_lateral. In the example of FIG. 12, the luminance is denoted as LM_lateral. In FIG. 12, LM_lateral is a normalized value. Hence, a maximum value of LM_lateral is 1.

FIG. 13 is a table showing a correspondence relationship between TV_lateral and LM_lateral seen in FIG. 12 as an example. For the sake of brevity, FIG. 13 shows only a portion of the entire correspondence relationship between TV_lateral and LM_lateral. As shown in FIGS. 12 and 13, LM_lateral increases as TV_lateral increases.

In the example of the first embodiment, TV_lateral has a minimum value of 0 and a maximum value of 255. If TV_lateral=0 holds, LM_lateral=0.001 holds. If TV_lateral=255 holds, LM_lateral=1 holds. As can be seen, in the example of the first embodiment, LM_lateral has a minimum value of 0.001 and a maximum value of 1.

LM_lateral has a minimum value of greater than 0 (in other words, LM_lateral is not 0 even though TV_lateral is 0). This is because a portion of the illuminating light emitted from the BL 32P reaches the second position. Hence, it can be said that the minimum value of LM_lateral is an index indicating the minimum leakage amount of the illuminating light to the second position.

As described above, the image correction unit 23 corrects the second image IMG2 in accordance with a data set indicating a luminance corresponding to each of a plurality of test patterns in which a black display image is displayed as the first image IMG1 and all the areas of the BL 32P are illuminated at the maximum luminance. Hence, as an example, the image correction unit 23 may have the table illustrated in FIG. 13 as an example. In this case, the image correction unit 23 corrects the second image IMG2 in accordance with the table. The correction on the second image IMG2 in accordance with the table is an example of the correction on the second image IMG2 in accordance with the data set described above.

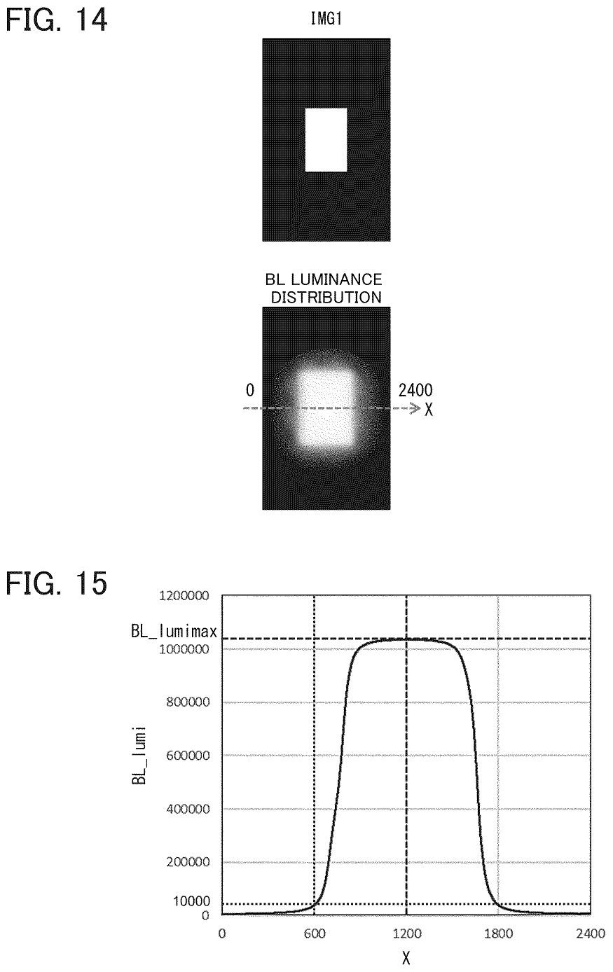

Described next will be an example of the correction on the second image IMG2 with image correction unit 23. FIG. 14 shows an example of the first image IMG1 according to the first embodiment and an example of BL luminance distribution corresponding to the first image IMG1. In FIG. 14, a first image IMG1 on the top is equivalent to the first image IMG1 illustrated in the example of the reference numeral 1030 described above.

As described above, the BL control unit 22P generates a BL data item corresponding to the first image IMG1 and each of the plurality of light sources 321 of the BL 32P. The BL data item is a data item representing the BL luminance distribution on the bottom in FIG. 14. The BL luminance distribution corresponds to the gray level distribution in the first image IMG1 shown on the top in FIG. 14. Hence, a high luminance area in the BL luminance distribution is found in a center portion of the BL 32P. Whereas, an area of the BL 32P other than the center portion is a low luminance area.

FIG. 14 shows an X-axis serving as an axis indicating a direction in which the BL luminance distribution is measured. The X-axis in the example of FIG. 14 is set to pass through a center of the light-emitting face of the BL 32P. In the example of FIG. 14, X has a minimum value of 0. X=0 is an X coordinate indicating a position of a left end of the BL 32P in the drawing. Whereas, in the example of FIG. 14, X has a maximum value of 2400. X=2400 is an X coordinate indicating a position of a right end of the BL 32P in the drawing.

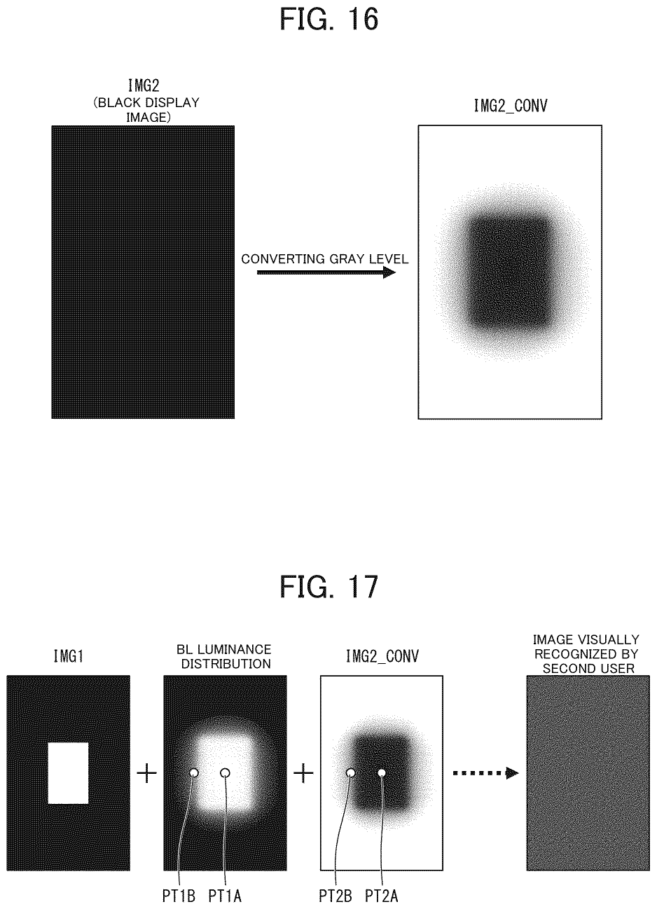

FIG. 15 is a graph showing the BL luminance distribution in the X-axis direction in the example of FIG. 14. In the graph of FIG. 15, the horizontal axis represents X and the vertical axis represents the BL luminance. In the example of FIG. 16, the BL luminance that the vertical axis represents is denoted as BL_lumi. Unlike LM_lateral described above, BL_lumi is non-normalized luminance.

In the graph of FIG. 15, BL_lumi has a maximum value at X=1200; that is, a center position of the BL 32P in the X-direction. In the example of FIG. 15, the maximum value of BL_lumi is denoted as BL_lumimax. In the example of FIG. 15, BL_lumimax=1030000 holds. As shown in FIG. 15, in a range of 0≤X≤1200, BL_lumi increases as X increases. Whereas, in a range of 1200≤X≤2400, BL_lumi decreases as X increases. As can be seen, the graph of FIG. 15 is symmetric in the X-direction.

In order to reduce the crosstalk visually recognized by the second user U2 at the second position because of the illuminating light emitted from the BL 32P, one of the solutions is to convert a gray level of the second image IMG2 in order to cancel the BL luminance distribution corresponding to the first image IMG1.

Thus, in the first embodiment, the image correction unit 23 calculates a target luminance BL_target in accordance with LM_lateral seen in the example of FIG. 13 and BL_lumimax seen in the example of FIG. 15.

As an example, the image correction unit 23 calculates BL_target in accordance with Equation (1) below.

$$BL\_target = BL\_lumimax \times LM\_lateral \qquad ( 1 )$$

In the example of the first embodiment, BL_lumimax=1030000 holds and LM_lateral=0.001 holds. Hence, in this example, the image correction unit 23 calculates a value of BL_target=1030 in accordance with Equation (1).

BL_target given by Equation (1) can be interpreted as a value indicating luminance of illuminating light leaking from an area of the BL 32P to the second position when the area is illuminated at the maximum luminance. Hence, one of the solutions is, for example, to convert a gray level of the second image IMG2 in accordance with BL_target, in order to cancel the BL luminance distribution corresponding to the first image IMG1.

FIG. 16 illustrates an exemplary correction on the second image IMG2 according to the first embodiment. In the example of FIG. 16, the second image IMG2 is a black display image. As will be described below, based on BL_target, the image correction unit 23 converts a gray level of the second image IMG2. In the example of FIG. 16, the second image IMG2 having the gray level converted with the image correction unit 23 is referred to as a converted second image IMG2_CONV.

In the example of FIG. 16, gray level distribution in the converted second image IMG2_CONV is in pair with the BL luminance distribution in the example of FIG. 14. Specifically, the gray level distribution in the converted second image IMG2_CONV basically corresponds to distribution obtained by inverting contrast of the BL luminance distribution. Hence, the converted second image IMG2_CONV has a low gray level area corresponding to a low luminance area in the BL luminance distribution. Whereas, the converted second image IMG2_CONV has a high gray level area corresponding to a high luminance area in the BL luminance distribution.

Studied here as an example are the first area AR1 and the second area AR2 in the BL 32P mentioned above in FIG. 9. In this example, luminance of the BL 32P in the first area AR1 is referred to as a first BL luminance, and luminance of the BL 32P in the second area AR2 is referred to as a second BL luminance. As illustrated in FIG. 9 as an example, studied here is a case where the first BL luminance is higher than the second BL luminance. In this case, as can be understood from the example of FIG. 16, in the converted second image IMG2_CONV, a gray level of an image area corresponding to the first area AR1 is lower than a gray level of an image area corresponding to the second area AR2 (see also FIG. 17 to be shown later).

Described next is a specific example of conversion of a gray level of the second image IMG2 in accordance with BL_target. The image correction unit 23 calculates BL_xt; that is, a value obtained by dividing BL_target of the BL 32P by BL_lumi.

That is, the image correction unit 23 calculates BL_xt in accordance with Equation (2) below.

$$BL\_xt = BL\_target / BL\_lumi \qquad ( 2 )$$

In an example of the first embodiment, BL_target=1030 holds. As an example, attention is directed to X=600 in FIG. 15. X=600 is an X coordinate indicating a position of a point PT1B in FIG. 17 to be seen later. As seen in FIG. 15, BL_lumi=10000 holds at X=600. Hence, the image correction unit 23 calculates BL_xt at X=600 in accordance with Equation (2) and obtains BL_xt=0.103.

BL_xt given by Equation (2) can be interpreted as a value indicating a luminance rate of illuminating light leaking from an area of the BL 32P to the second position when the area is illuminated at the luminance BL_lumi. Hence, BL_xt can be understood as a value corresponding to LM_lateral. Thus, for example, using the table of FIG. 13 above as a lookup table, TV_lateral corresponding to the BL_xt can be determined. That is, a gray level of the converted second image IMG2_CONV corresponding to BL_xt can be determined.

Hence, the image correction unit 23 determines TV_lateral corresponding to BL_xt=0.103 by performing a lookup on the table of FIG. 13. In other words, the image correction unit 23 determines a value found on the horizontal axis of the graph in FIG. 12 and corresponding to a value “0.103” on the vertical axis of the graph as TV_lateral corresponding to Bl_xt=0.103.

In the examples of FIGS. 12 and 13, LM_lateral=0.103 corresponds to TV_lateral=100. Hence, in the above examples, the image correction unit 23 determines TV_lateral corresponding to BL_xt=0.103 as TV_lateral=100.

The image correction unit 23 sets TV_lateral, which is determined for a certain position (e.g., a certain value of X) of the BL 32P, as the gray level of the converted second image IMG2_CONV at a position corresponding to the position of the BL 32P. In the above example, the image correction unit 23 sets, to 100, the gray level of the converted second image IMG2_CONV at a position corresponding to X=600. In this way, the image correction unit 23 converts a gray level “0” of the second image IMG2 found at the position corresponding to X=600 to a gray level “100” of the converted second image IMG2_CONV.

### Advantageous Effects

As described above, the image correction unit 23 can convert a gray level of the second image IMG2 in accordance with (i) the BL luminance distribution corresponding to the first image IMG1 and (ii) a data set indicating a luminance corresponding to each of a plurality of test patterns in which a black display image is displayed as the first image IMG1 and all the areas of the BL 32P are illuminated at the maximum luminance.

The image correction unit 23 converts a gray level of the second image IMG2 as described above so as to generate the converted second image IMG2_CONV. Hence, under the BL luminance distribution corresponding to the first image IMG1, the display device 1P can present the converted second image IMG2_CONV to the second user U2 at the second position.

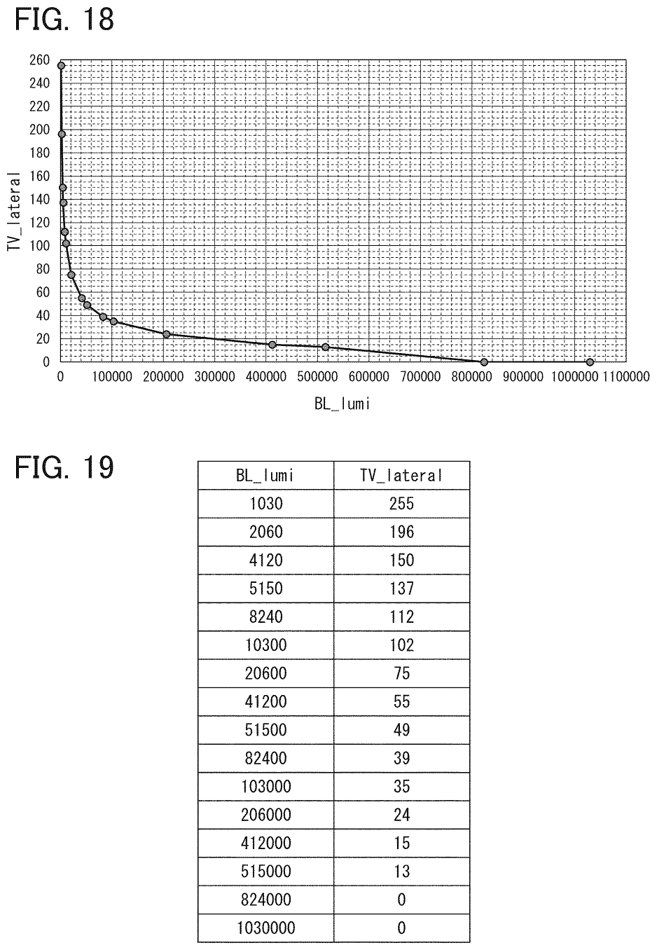

FIG. 17 shows an exemplary case where the converted second image IMG2_CONV, which is illustrated in FIG. 16 as an example, is presented to the second user U2 under the BL luminance distribution corresponding to the first image IMG1. In FIG. 17, the point PT1A indicates a position of the BL 32P represented as X=1200 and seen in the X-direction. As described above, at the point PT1A, BL_lumi=BL_lumimax=103000 holds. Whereas, a point PT1B in FIG. 18 indicates a position of the BL 32P represented as X=600 and seen in the X-direction. As described above, at the point PT1B, BL_lumi=10000 holds. Hence, the BL luminance at the point PT1A is higher than the BL luminance at point PT1B.

In FIG. 17, a point PT2A indicates a position, of the converted second image IMG2_CONV, corresponding to the point PT1A. A point PT2B indicates a position, of the converted second image IMG2_CONV, corresponding to the point PT1B. As described above, the display device 1P can generate the converted second image IMG2_CONV having gray level distribution in pair with BL luminance distribution. Hence, a gray level of the converted second image IMG2_CONV at the point PT2A is lower than a gray level of the converted second image IMG2_CONV at the point PT2B.

As seen in FIG. 17, the gray level distribution of the converted second image IMG2_CONV cancels the BL luminance distribution corresponding to the first image IMG1. Such a feature allows the second user U2 at the second position to visually recognize an image having mostly uniform luminance distribution. As can be seen, compared with the example of the reference numeral 1030, the display device 1P can reduce crosstalk visually recognized by the second user U2 at the second position.

As can be seen, the display device 1P can reduce crosstalk visually recognized by the second user U2 at the second position while driving the BL 32P with LD ON. Hence, thanks to the display device 1P, a multi-view display device can achieve higher display quality than ever before. Specifically, thanks to the display device 1P, an LD multi-view display device can achieve higher display quality than ever before.

### Supplementary Comments

As can be understood from the above description of the first embodiment, BL_lumi and the TV_lateral correspond to each other on one-on-one basis. FIG. 18 is a graph showing an exemplary correspondence relationship between BL_lumi and TV_lateral according to the first embodiment. FIG. 18 exemplifies the correspondence relationship observed when L_target=1030 holds. In the graph of FIG. 18, the horizontal axis represents BL_lumi and the vertical axis represents TV_lateral.

FIG. 19 is a table showing a correspondence relationship between BL_lumi and TV_lateral seen in FIG. 18 as an example. For the sake of brevity, FIG. 19 shows only a portion of the entire correspondence relationship between BL_lumi and TV_lateral. The image correction unit 23 may determine TV_lateral corresponding to BL_lumi, using the table illustrated in FIG. 19 as an example. That is, the image correction unit 23 may correct the second image IMG2 in accordance with the table. The correction on the second image IMG2 in accordance with the table is also an example of the correction on the second image IMG2 in accordance with the data set described above.

As can be understood from FIGS. 18 and 19, in the first embodiment, TV_lateral decreases as BL_lumi increases. Hence, in the first embodiment, the larger BL_lumi is, the smaller a gray level is set for the converted second image IMG2_CONV corresponding to BL_lumi. Such a feature makes it possible to obtain the gray level distribution to be provided for the converted second image IMG2_CONV and capable of cancelling the BL luminance distribution corresponding to the first image IMG1.

### Exemplary Implementation in Form of Software

Functions of each of the display devices 1 and 1P (hereinafter collectively referred to as a “device”) are implemented in a form of a program for causing a computer to function as the device and as the control blocks (in particular, the units included in the control unit 2 and 2P) of the device.

In this case, the device includes a computer having at least one control device (e.g., a processor) and at least one storage device (e.g., a memory), both of which serve as hardware for executing the above program. The control device and the storage device execute the program to achieve the functions described in the above embodiments.

The program may be recorded on one or a plurality of non-transitory computer-readable recording media. Such recording media may or may not be included in the above device. In the latter case, the program may be supplied to the device through any given wired or wireless transmission medium.

The functions of the control blocks can be partially or entirely implemented in the form of a logic circuit. For example, an integrated circuit forming a logic circuit functioning as the control blocks is also included in the scope of one aspect of the present disclosure. Otherwise, the functions of the control blocks can be implemented in a form of, for example, a quantum computer.

The processing described in the above embodiments may be executed by artificial intelligence (AI). In this case, the AI may operate on the control device or on another device (e.g., an edge computer or a cloud server).

### Summary

A display device according to a first aspect of the present disclosure is capable of presenting a first image to a first user positioned in front of a display surface and a second image to a second user positioned lateral to the display surface. The second image is different from the first image. The display device includes: a display panel having a first display pixel group for forming the first image on the display surface and a second display pixel group for forming the second image on the display surface; a backlight that emits illuminating light toward the first display pixel group and the second display pixel group; a barrier that prevents a portion of a first light and a portion of a second light from traveling toward the display surface, the first light being the illuminating light having a wavelength converted with the first display pixel group, and the second light being the illuminating light having a wavelength converted with the second display pixel group; and a control unit that controls the display panel and the backlight. The backlight is divided into a plurality of areas. The backlight has a light source for each of the plurality of areas. The light source is allowed to be independently controlled in each of the plurality of areas. A data set is prepared in advance to indicate a luminance corresponding to each of a plurality of test patterns in which a black display image is displayed as the first image and all the areas of the backlight are illuminated at maximum luminance. The control unit converts a gray level of the second image in accordance with luminance distribution observed of the backlight and corresponding to the first image and with the data set.

As to the display device in a second aspect of the present disclosure according to the first aspect, the backlight may have, as the plurality of areas, a first area and a second area different from the first area, a first backlight luminance that is luminance of the backlight in the first area may be higher than a second backlight luminance that is luminance of the backlight in the second area, and in the second image after the conversion, a gray level of an image area corresponding to the first area may be lower than a gray level of an image area corresponding to the second area.

As to the display device in a third aspect of the present disclosure according to the first or the second aspect, a converted second image, which is the second image having the gray level converted, may be presented to the second user under the luminance distribution observed of the backlight and corresponding to the first image.

As to the display device in a fourth aspect of the present disclosure according to any one of the first to the third aspects, the plurality of test patterns may include: a test pattern in which a black display image is displayed as the first image, a white display image is displayed as the second image, and all the areas of the backlight are illuminated at the maximum luminance; a test pattern in which a black display image is displayed as the first image, a black display image is displayed as the second image, and all the areas of the backlight are illuminated at the maximum luminance; and a test pattern in which a black display image is displayed as the first image, a halftone display image is displayed as the second image, and all the areas of the backlight are illuminated at the maximum luminance.

As to the display device in a fifth aspect of the present disclosure according to any one of the first to the fourth aspects, the display panel may be a liquid crystal display panel.

### Additional Remarks

An aspect of the present disclosure shall not be limited to the embodiments described above, and can be modified in various manners within the scope of claims. The technical aspects disclosed in different embodiments are to be appropriately combined together to implement another embodiment. Such an embodiment shall be included within the technical scope of the aspect of the present disclosure. Moreover, the technical aspects disclosed in each embodiment may be combined together to achieve a new technical feature.

What is claimed is:

1. A display device capable of presenting a first image to a first user positioned in front of a display surface and a second image to a second user positioned lateral to the display surface, the second image being different from the first image, and the display device comprising:
a display panel having a first display pixel group for forming the first image on the display surface and a second display pixel group for forming the second image on the display surface;
a backlight configured to emit illuminating light toward the first display pixel group and the second display pixel group;
a barrier configured to prevent a portion of a first light and a portion of a second light from traveling toward the display surface, the first light being the illuminating light having a wavelength converted with the first display pixel group, and the second light being the illuminating light having a wavelength converted with the second display pixel group; and
a control unit configured to control the display panel and the backlight,
wherein the backlight is divided into a plurality of areas,
the backlight has a light source for each of the plurality of areas,
the light source is allowed to be independently controlled in each of the plurality of areas,
a data set is prepared in advance to indicate a luminance corresponding to each of a plurality of test patterns in which a black display image is displayed as the first image and all the areas of the backlight are illuminated at maximum luminance, and
the control unit converts a gray level of the second image in accordance with luminance distribution observed of the backlight and corresponding to the first image and with the data set.

2. The display device according to claim 1,
wherein the backlight has, as the plurality of areas, a first area and a second area different from the first area,
a first backlight luminance that is luminance of the backlight in the first area is higher than a second backlight luminance that is luminance of the backlight in the second area, and
in the second image after the conversion, a gray level of an image area corresponding to the first area is lower than a gray level of an image area corresponding to the second area.

3. The display device according to claim 1,
wherein a converted second image, which is the second image having the gray level converted, is presented to the second user under the luminance distribution observed of the backlight and corresponding to the first image.

4. The display device according to claim 1,
wherein the plurality of test patterns includes:
a test pattern in which a black display image is displayed as the first image, a white display image is displayed as the second image, and all the areas of the backlight are illuminated at the maximum luminance;
a test pattern in which a black display image is displayed as the first image, a black display image is displayed as the second image, and all the areas of the backlight are illuminated at the maximum luminance; and
a test pattern in which a black display image is displayed as the first image, a halftone display image is displayed as the second image, and all the areas of the backlight are illuminated at the maximum luminance.

5. The display device according to claim 1,
wherein the display panel is a liquid crystal display panel.
